(19) United States
(12) Patent Application Publication
(10) Pub. No.: US 2009/0201610 A1
(43) Pub. Date: Aug. 13, 2009

(54) TAPE GUIDE ROLLERS

(75) Inventors: ARMANDO J. ARGUMEDO, Tucson, AZ (US); KEVIN B. JUDD, Tucson, AZ (US)

Correspondence Address: HAMILTON & TERRILE, LLP;IBM Tucson, P.O. BOX 203518, AUSTIN, TX, 78720, US

(73) Assignee: International Business Machines Corporation, Armonk, NY (US)

(21) Appl. No.: 12/029,999

(22) Filed: Feb. 12, 2008

(51) Int. Cl. G11B 5/78

(52) U.S. Cl. 360/134

(57) ABSTRACT

A tape guide roller includes a first flange and a second flange separated by a barrel wherein at least one of the first flange and second flange comprise a soft material. The soft material can include acetal homopolymers, such as Delrin. It can also include soft metals, such as aluminum.

### FIELD OF INVENTION

The present invention generally relates to tape storage devices. More specifically, the invention relates guide rollers in tape storage devices.

### BACKGROUND OF THE INVENTION

Magnetic tape storage devices are a popular data storage device. In such devices, a magnetic tape is wound and unwound between two reels to contact a read and write head. Tape guide rollers define the path of the magnetic tape to provide a well defined path. Guide rollers do not typically drive the tape along its path.

In applications subject to significant usage, the tape guide rollers are subject to a significant level of contact with the magnetic tape. This contact gives rise to substantial wear issues, and can adversely affect the life span of the tape drive and the tape by either leaving residue and debris of the magnetic tape on the tape guide roller or by deforming the magnetic tape itself, such as by fraying the edges of the tape.

Historically, the solution to these wear problems has been an increase in the hardness of the material used for the guide rollers. While these harder materials have been generally effective in reducing wear problems, these materials are typically expensive. Additionally, as the media used for the magnetic tape itself has changed, failure modes are trending away from wear induced failure and trending toward debris induced failure. A method for eliminating or reducing the amount of wear that occurs on a tape guide roller, while also eliminating or reducing the amount of debris that can adhere to the tape guide roller is desired.

In one embodiment of guide rollers that are typical, the tape guide roller has a three piece construction such that metallic side flanges surround a metallic barrel where the tape rides. The width of the barrel is designed to match the width of the tape closely to increase the accuracy of tape tracking. The three pieces are generally press fit together. In another embodiment, the tape guide roller has a one piece construction where the flanges and the barrel are all constructed from a single part.

It is therefore a challenge to develop strategies for advancing the art to overcome these, and other, disadvantages.

### SUMMARY OF THE INVENTION

A first embodiment of the present invention is a tape guide roller including a first flange and a second flange separated by a barrel wherein at least one of the first flange and second flange comprise a plastic material.

A second embodiment of the present invention is a tape guide roller including a first flange and a second flange separated by a barrel wherein at least one of the first flange and second flange comprise a soft metal, such as aluminum.

A third embodiment of the present invention is a one piece tape guide roller that is comprised of a plastic material.

A fourth embodiment of the present invention is a one piece tape guide roller that is comprised of a soft metal, such as aluminum.

Yet another embodiment of the present invention is a magnetic storage device including a first reel defining an origin of a tape path, a second reel defining a terminus of the tape path and a read/write head disposed along the tape path. In addition, the magnetic storage device includes at least one tape guide roller defining the tape path between the origin and terminus comprising a first flange and a second flange separated by a barrel wherein at least one of the first flange and second flange comprise a plastic material.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a tape guide roller in accordance with one aspect of the invention;

FIG. 2 illustrates one embodiment of a magnetic storage device in accordance with one aspect of the invention; and

FIG. 3 illustrates one embodiment of a magnetic storage device in accordance with one aspect of the invention.

### DETAILED DESCRIPTION OF THE PRESENT INVENTION

In experiments to study tape guide roller wear, guide rollers made of aluminum were constructed. When these rollers were analyzed after many new tapes had been run in the drive, the wear on the guide roller was of a type that had not been previously observed. Instead of the wear marks that were historically observed in the stainless steel rollers (which can cause problems for the track following system), the aluminum rollers had a wide and highly polished smooth wear zone.

This unexpected observation led to the further investigation of using soft materials for guide rollers. Eventually, plastic rollers were procured for investigation. Various types of plastics were tested, and Delrin AF® presented advantageous properties including reduced debris generation and reduced wear on the tape guide rollers

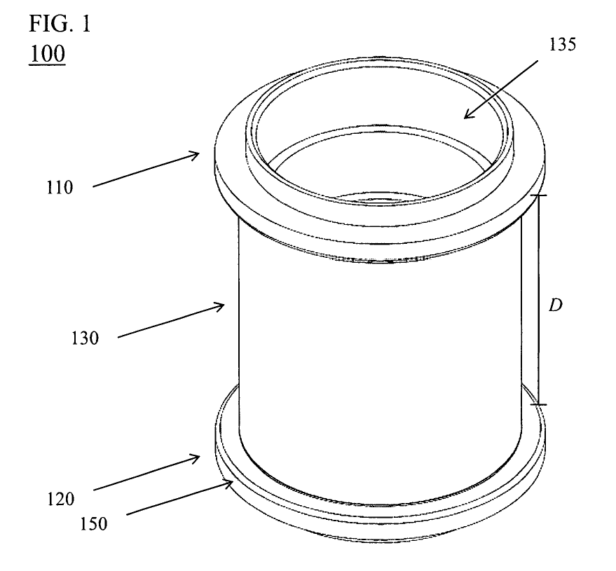

FIG. 1 illustrates a tape guide roller 100 in accordance with one aspect of the invention. Tape guide roller 100 includes a first flange 110 and a second flange 120. Tape guide roller 100 is substantially cylindrical and includes an outer barrel surface 130 and an inner diameter 135. The barrel 130 is configured to receive magnetic tape and to define at least a portion of the path of the magnetic tape. In one embodiment, the distance D between the first flange 110 and second flange 120 is tailored to fit as closely as practicable the width of the magnetic tape to be used in the magnetic storage device including the tape guide roller 100. In various embodiments, at least one of the first flange 110 and second flange 120 include at least one beveled surface 150.

At least one of the first flange 110, second flange 120 and barrel are made of a plastic material. In one embodiment, the plastic material includes an acetal homopolymer resin. In one embodiment, the plastic material includes Delrin. In one such embodiment, the plastic material includes approximately 80% Delrin and 20% PTFE. In one embodiment, the plastic material includes polyoxymethylene. In one embodiment, each of the first flange 110, second flange 120 and barrel are made of a plastic material. In one embodiment, each of the first flange 110 and second flange 120 are made of the plastic material, while the barrel 130 is made of a metal material. The metal material can be any appropriate metal as used in the prior art, such as stainless steel. In one embodiment, the flange material is not plastic, and is instead a material with a Rockwell A hardness less than 50.

Tape guide roller 100, in one embodiment, comprises a three-piece construction, such that each of the first flange 110 and second flange 120 are attached to the barrel 130. In one embodiment, the attachment includes a press fit. In another embodiment, the attachment includes a dovetail joint achieved by sliding the respective pieces transverse to the barrel axis. In another embodiment, at least one of the first flange 110 and second flange 120 are clamped to the barrel 130. In another embodiment, the entire tape guide roller 100 is made from molded plastic material for one-piece construction.

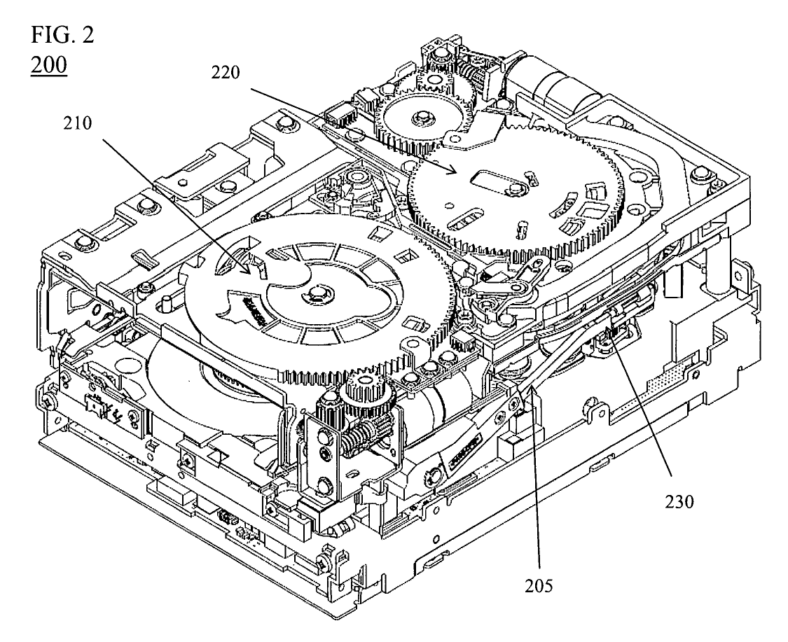

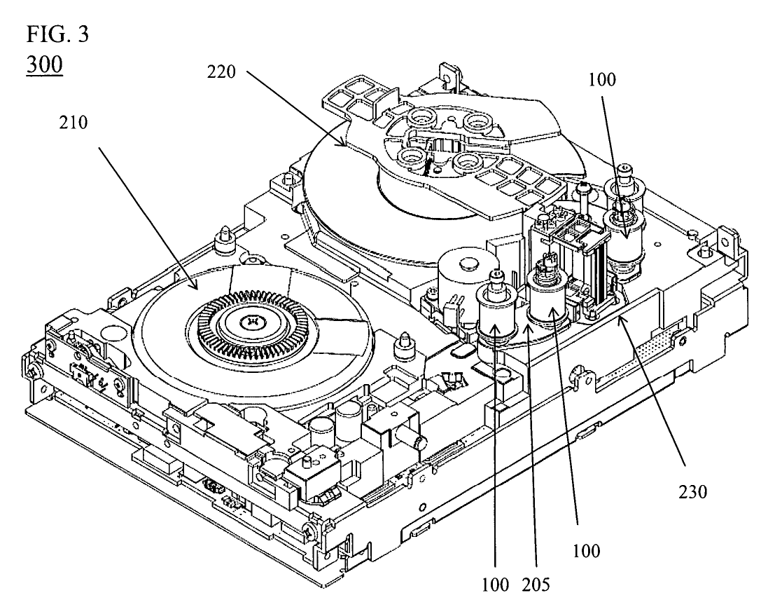

FIG. 2 illustrates one embodiment of a magnetic storage device 200 in accordance with one aspect of the invention. Magnetic storage device 200 includes a motor 210 where a removable cartridge reel is placed. The origin of a tape path 205 is defined by the motor and a second wheel 220 defines a terminus of the tape path 205. A read/write head 230 is disposed along the tape path 205 and operable to read and write magnetic information on a magnetic tape. Magnetic storage device 200 further includes at least one tape guide roller 100. The tape guide roller 100 is as described with reference to FIG. 1. FIG. 3 illustrates the magnetic storage device 200 without a cover plate, and more clearly shows the read/write head 230 and tape guide rollers 100.

When a magnetic tape is operably placed into the magnetic storage device, the tape will traverse the tape path 205 from the first wheel 210 to the second wheel 220, where the tape will be taken up. Along tape path 205, the tape will operably contact the read/write head for the accessing or storage of data. The tape path is defined by the starting position of the tape and the ending position of the tape, as directed by the tape guide rollers. Since the tape position at the origin and terminus changes slightly as the tape is unwound from the first wheel, and taken up by the second, the tape path is desirably controlled by a plurality of guide wheels positioned to ensure that the position of the tape traversing the read/write head is substantially constant. In one embodiment, the tape guide rollers are situated adjacent the read/write head in the tape path 205.

In experiments tests conducted with the rollers that are known in the art, debris was observed to stick onto flange 110 or 120 after significant amounts of tape were run through the drive. The debris can cause excessive lateral motion of the tape, which the track following system on the read/write head will not be able to follow. Experimental results with rollers with aluminum flanges that ran approximately the same amount of tape resulted in a zone near the barrel/flange intersection that has a wide smooth area without debris. As the tape edge is located in this area of the flange, the tape edge is presented with a smooth surface to contact. Experimental results with rollers with Delrin AF flanges that ran approximately the same amount of tape resulted in no debris sticking to the flange surface. Also the surface of the flange near the barrel was polished by tape motion.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A tape guide roller comprising:
a first flange;
a second flange; and
a barrel between the first flange and second flange, wherein at least one of the first flange and second flange comprise a plastic material.

2. The roller of claim 1 wherein the plastic material comprises an acetal homopolymer resin.

3. The roller of claim 2 wherein the plastic material comprises Delrin®.

4. The roller of claim 1 wherein the plastic material comprises polyoxymethylene.

5. The roller of claim 1 wherein each of the first flange, second flange, and barrel comprises the plastic material.

6. The roller of claim 1 wherein the first flange and second flange and barrel comprise a one-piece construction.

7. A magnetic storage device comprising:
a first wheel defining an origin of a tape path;
a second wheel defining a terminus of the tape path;
a read/write head disposed along the tape path; and
at least one tape guide roller defining the tape path between the origin and terminus comprising a first flange and a second flange separated by a barrel wherein at least one of the first flange and second flange comprise a plastic material.

8. The device of claim 7 wherein the plastic material comprises an acetal homopolymer resin.

9. The device of claim 8 wherein the plastic material comprises Delrin®.

10. The device of claim 7 wherein the plastic material comprises polyoxymethylene.

11. The device of claim 7 wherein each of the first flange, second flange, and barrel comprises the plastic material.

12. The device of claim 7 wherein the at least one tape guide roller is situated adjacent to the read/write head.

13. A tape guide roller comprising:
a first flange;
a second flange; and
a barrel between the first flange and second flange, wherein at least one of the first flange and second flange comprise a material with Rockwell A hardness less than substantially 50.

14. The roller of claim 13 wherein the material is aluminum.
